(19) United States
(12) Patent Application Publication
(10) Pub. No.: US 2012/0185496 A1
(43) Pub. Date: Jul. 19, 2012

(54) METHOD OF AND A SYSTEM FOR RETRIEVING INFORMATION

(75) Inventors: Walid Magdy, Giza (EG); Gareth J. Jones, Dublin (IE)

(73) Assignee: DUBLIN CITY UNIVERSITY, Dublin (IE)

(21) Appl. No.: 13/351,895

(22) Filed: Jan. 17, 2012

Related U.S. Application Data
(60) Provisional application No. 61/433,784, filed on Jan. 18, 2011.

(51) Int. Cl. G06F 17/30

(52) U.S. Cl. 707/760; 707/E17.062

(57) ABSTRACT

A method of retrieving information from a data source is described. The method includes providing a query sentence in a source language. A stemmed sentence is generated by removing affixes from base words of the query sentence and by removing predetermined words from the query sentence. A translated sentence is generated by translating the stemmed sentence into a target language. The translated sentence is provided to an information retrieval module operable to retrieve information in the target language from the data source based on the translated sentence.

### CROSS REFERENCE TO RELATED APPLICATION

This application claims benefit under 35 U.S.C. 119(e) of U.S. Provisional Patent Application Ser. No. 61/433,784, filed Jan. 18, 2011, which is incorporated herein by reference in its entirety.

### FIELD OF THE INVENTION

The present teaching relates to a method of and system for retrieving information. In particular, the teaching relates to cross language information retrieval.

### BACKGROUND

Cross language information retrieval (CLIR) is concerned with searching for information in a different language from a query. CLIR processes known heretofore require significant computer resources in order to complete translation and text processing requirements. The time required completing translation and text processing requirements significantly delays the information retrieval process.

There is therefore a need for a method of and system for retrieving information which addresses at least some of the drawbacks of the prior art.

### SUMMARY

The present teaching relates to a machine translation (MT) system, and in particular to a machine translation system configured for cross language information retrieval (CLIR). The workflow of the MT system includes a text processing step in advance of a translation step.

Accordingly, a first embodiment of the teaching provides a method as detailed in claim 1. The teaching also provides a cross language information retrieval system as detailed in claim 6. Additionally, the teaching relates to a desktop search tool as detailed in claim 11. Furthermore, the teaching relates to an information retrieval environment as detailed in claim 12. The teaching also relates to an article of manufacturer as detailed in claim 13. Advantageous embodiments are provided in the dependent claims.

These and other features will be better understood with reference to the followings Figures which are provided to assist in an understanding of the teaching of the invention.

### BRIEF DESCRIPTION OF THE DRAWINGS

The present invention will now be described with reference to the accompanying drawings in which:

FIG. 1 is a diagrammatic representation of a prior art information retrieval workflow.

FIG. 2 is a detail of block 110 of FIG. 1.

FIG. 3 is a diagrammatic representation of an information retrieval work flow in accordance with the present teaching.

FIG. 4 is a detail of block 210 of FIG. 3.

FIG. 5 is a detail of block 211 of FIG. 4.

FIG. 5A is an example of what the machine translation system will produce as a result of performing the acts of FIG. 5 within the translation act, rather than subsequently.

FIG. 5B is an example of what the machine translation system would have produced as a result of performing the acts of FIG. 5 subsequently following the translation act.

FIG. 6 are graphs used to compare the workflow of FIG. 3 against the workflow of FIG. 1.

FIG. 7 is a machine translation system configured to implement the workflow of FIG. 4.

### DETAILED DESCRIPTION OF THE DRAWINGS

The invention will now be described with reference to an exemplary cross language information retrieval system which is provided to assist in an understanding of the teaching of the invention.

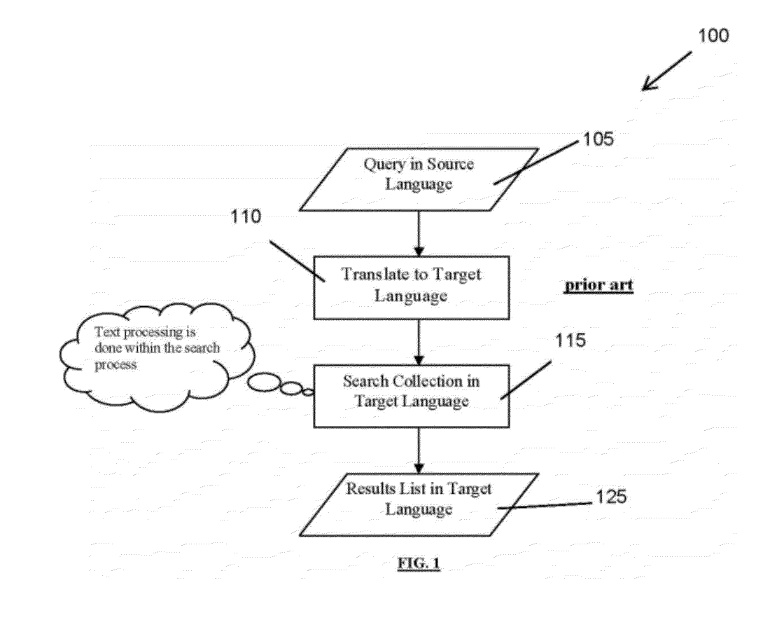

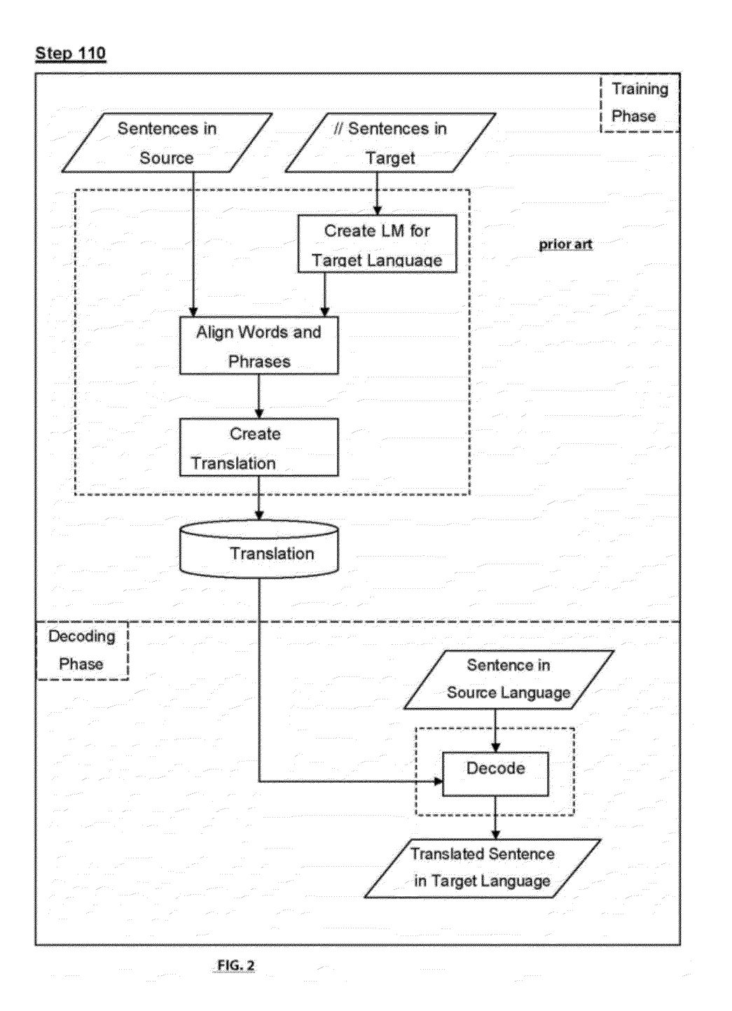

Referring initially to FIGS. 1 and 2 there is illustrated a workflow 100 of a known cross language information retrieval (CLIR) system. Cross language information retrieval (CLIR) is concerned with searching a collection of documents that are in a different language from the query sentence. This kind of search is very useful in many situations. For example, when the user is capable of understanding more than one language, but can only write queries effectively in their native language. They may then be interested to find relevant documents in more than one language. The workflow 100 initiates with the generation of a query sentence by a user in a source language, step 105. The query sentence is then translated by a machine translation module into a target sentence, step 110. The translated sentence is then processed after the machine translation module by removing affixes and stop words thereby generating a stemmed sentence. The stemmed sentence is applied to a search engine (information retrieval module) and is used by the search engine to retrieve relevant documents, step 115. However, the translated version of the query sentence may include stop words such as ‘is, it, are, the, this, that’ which are typically filtered out of the query within step 115. The process of translating the query sentence to a target language is significantly slowed as result of the stop words, which in turn delays the completion of the information retrieval step in order to get results 125.

The main objective of an information retrieval system is to find documents that match the query at the conceptual level of the sentence. For example, when a query contains the word “calculate”, then most probably the user is interested in the documents that include the base element ‘calculat’ such as ‘calculates’, ‘calculated’, ‘calculating’, ‘calculation’, ‘calculations’. Typically the stemming of words in a query sentence is a standard pre-processing step prior to the information step. Stemming is a process that converts any base form of the word to its stem version by removing affixes such as suffixes, prefixes and infixes depending on the language. For example, the words ‘calculates’, ‘calculated’, ‘calculating’, ‘calculation’, ‘calculations’ would be stemmed to the word “calculat”, which is the main stem. The main stem may be considered as the base word to which the following affixes may be added “e’, ‘ed’, ‘es’, ‘ing’, ‘ion’, ‘ions’. In addition, there are many terms in the query that carry insignificant value to the conceptual meaning. These terms are very common words typically including: is, it, are, the, this, that . . . etc. These terms are called the stop words, and these are generally filtered out of the query before running the information retrieval step. Any group of words may be selected as the stop words for a given purpose. The stemming and removal of stop words is undertaken in a text processing step. In the cross language information retrieval workflow 100 the text processing step occurs after the translation step.

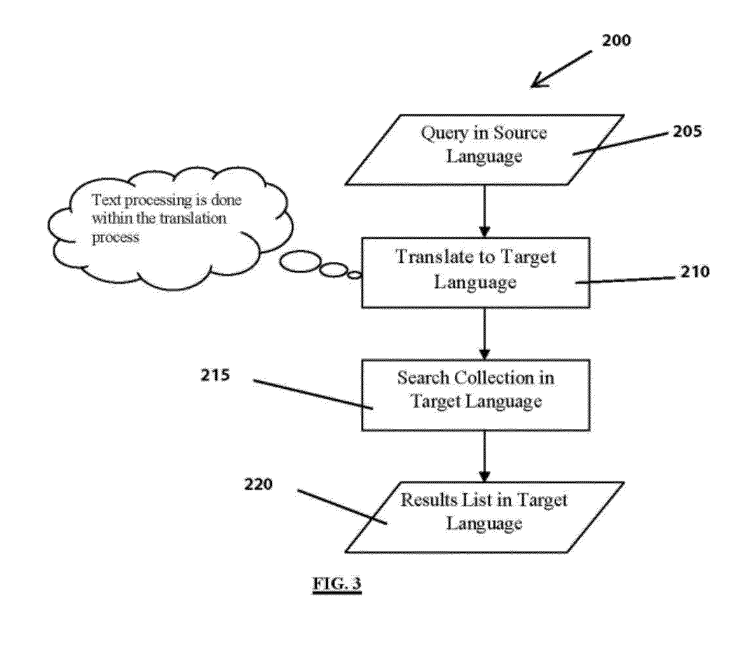

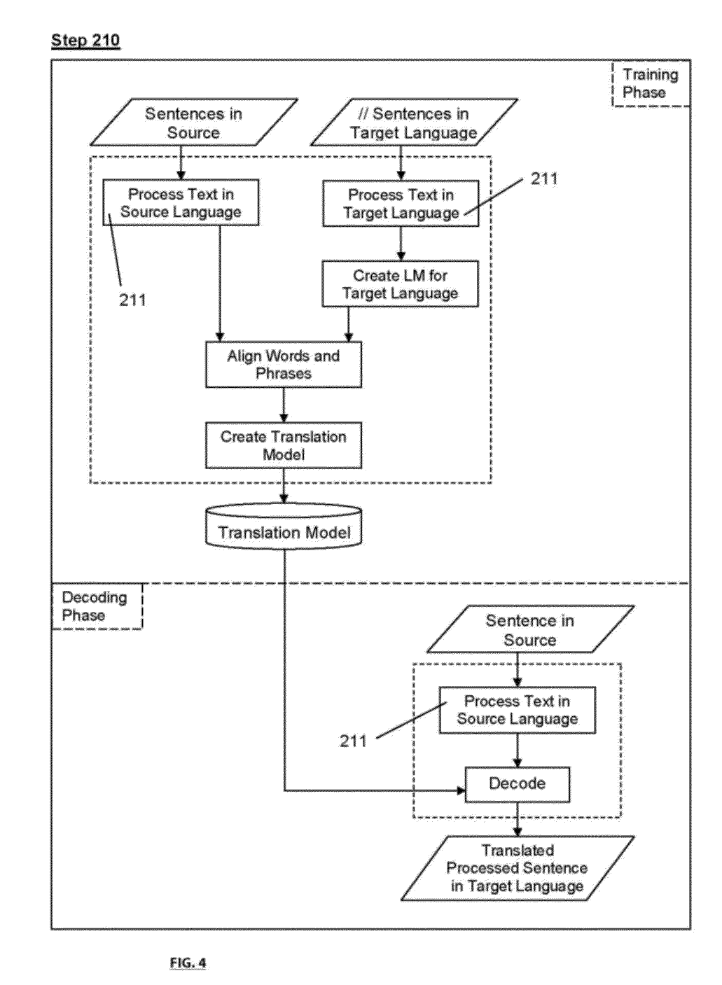

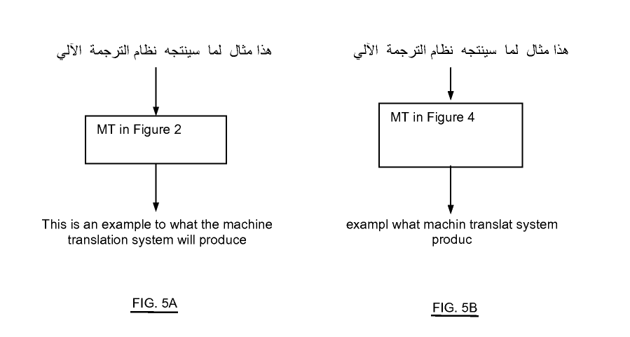

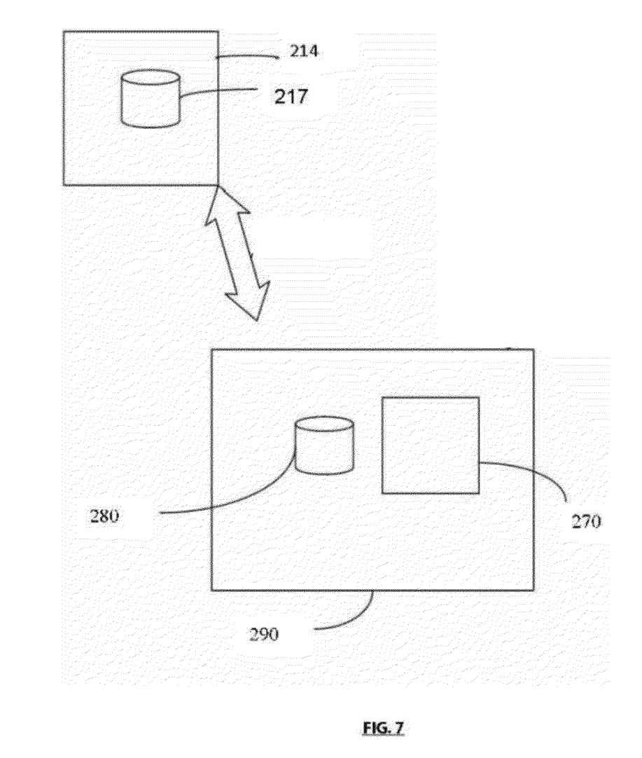

The present inventors have realised that the efficiency of the workflow 100 can be significantly increased by positioning the text processing step prior to the translation step as illustrated in the workflow 200 of FIGS. 3 and 4. The workflow 200 initiates with the generation of a query sentence by a user in a source language, step 205. The user inputs the query sentence through a user interface. A machine translation module 214 generates a processed sentence by performing the steps of FIG. 5 by removing affixes such as prefixes, suffixes and infixes from base words of the query sentence and by removing stop words. The processed sentence is then translated by the machine translation module 214 of FIG. 7 into a target sentence, steps 210 and 211. The translated sentence of step 210 is then used by an information retrieval module 290 when performing the information retrieval step 215. The information retrieval module 220 returns relevant information and/or documents from a data source based on the translated sentence. The information retrieval module 290 is operable to search in data sources for document(s), metadata about document(s), content within document(s), content on the World Wide Web, and content in relational database(s).

The translation steps of workflows 100 and 200 are implemented by machine translation (MT) modules which are configured to generate translations on the basis of statistical models whose parameters are derived from the analysis of bilingual text corpora. The MT modules are operable to generate an MT target text output in response to a source text input. The MT module which implements the work flow 100 is optimised for translating whole sentences from one language to a target language while preserving the target translated sentence in a correct morphological, semantic, and syntactic form. The MT system which implements the workflow 200 provides an output which is not morphological, semantic, and syntactic correct but provides suitable base words which may used in the information retrieval step 215. To illustrate the difference between the workflow 100 and the workflow 200 the same query sentence in a source Arabic language is applied to both workflows. However, the outputs are quite different as result of performing the text processing steps of FIG. 5 within the translation step, as illustrated in FIG. 5A, rather than subsequently, as illustrated in FIG. 5B.

Information retrieval research has been using machine translation modules/systems to translate text for years as black boxes. MT focuses on generating a translation that is morphologically, semantically, and syntactically correct. The most confusing parts for MT systems while translating a sentence is the selection of the proper pronouns (I, he, she, his, her, that), verb form (is, are, was, be), and verb tense (play, played, playing). This kind of confusion requires a large amount of training parallel corpus to build a reliable translation model, and a large amount of time and processing power to execute an effective algorithm for selecting the proper words. On the other hand, information retrieval modules/systems care more about the conceptual meaning of the word regardless to its surface form and tense. In addition, all the pronouns are considered insignificant to the meaning of the sentence for information retrieval purposes and are usually taken out of the query and the documents prior to performing the information retrieval step. The main issue in cross language information retrieval when machine translation modules are used to translate queries is that the machine translation modules take significant time selecting proper sentence structure, which is totally neglected later by the information retrieval module which implements the information retrieval step. In the workflow 100 the information retrieval module performs the steps of FIG. 5 by processing the translated sentence produced by the translation module to remove stop words (pronouns, insignificant verbs (e.g., is, are, were)) thereby rendering the high quality translated sentence into its basic components prior to performing the information retrieval step. In other words the information retrieval module does not require the high quality sentence produced by the translation module despite requiring a large amount of training data and significant computational resources to translate it. The present teaching provides a workflow 200 where the machine translation module 214 processes a sentence from a source language and translates it into a translated target query which significantly reduces the amount of training data and computational resources required. The translated target query is stored in a database 217.

The machine translation module 214 is configured to carry out the text processing step of FIG. 5 by stemming the query sentence in the source language and removing unnecessary stop words in advance of generating the translated target sentence. The translated target sentence is then applied to the information retrieval module 290 which is configured to implement the information retrieval step 215.

The workflow 200 could be implemented on a multilingual desktop search. Desktop search is the common name for search tools which search the contents of a user's own computer files. Desktop search tools are configured to find information on the user's PC such as text documents, images and video, audio files, web browser histories, e-mail archives, text documents, sound files, and images and video. Desktop search is a very useful service that allows users to find relevant content on their machines in an efficient amount of time. Desktop search is typically done in a monolingual fashion, where the results retrieved match the language of the query. The present teaching also relates to a desktop search tool which is configured to implement the workflow 200 thereby allowing users to search for multilingual content stored on personal desktop computers or other electronic devices such as laptops, smart phones, personal digital assistants (PDA), and handheld devices. A desktop search tool which is operable to implement the workflow 200 is very useful for people who work in languages other than their native language. For example, for an Arabic user, usually the content of his desktop machine or smart phone are typically in a mixture of Arabic and English. Applying desktop search to this content would be much better if the results can be retrieved for both languages. This kind of multilingual desktop search is seen to be impractical using the limited processing power of current PC's and smart phones because of the high computational power and resource requirements needed to implement the workflow 100. The workflow 200 is more efficient in requirements such as training resources, processing power, memory, and time, which permits the implementation of workflow 200 in a multilingual desktop search tool/application. The workflow 200 could also be implemented in a web search tool or a database search tool or in any other search tool.

The implementation of the workflow 200 was tested using three main criteria. The first criteria relates to testing the effect of processing the text in step 210 of the workflow 200 on the quality of the translated text, which will be reflected in the retrieval effectiveness of step 215. The second criteria relates to testing the efficiency of the proposed translation process according to the computational requirements for training and decoding when compared to translating the full sentence. However, more emphasis is given to the decoding time since it is the online time for translating the query which is generally more significant to the user. The third criteria test the effect of using a limited amount of training data on the retrieval effectiveness of step 215.

The cross language search task in CLEF-IP 2010 (Cross-Language Evaluation Forum, Intellectual Property track) was adopted for testing the present teaching. The main objective was to find relevant patent specifications in an English collection that are related to patent applications filed in French and German languages. The collection consists of 1.35 million patents from the European Patent Office (EPO) with 69% of them totally in English and 31% in German and French. However, the German and French patents in the collections have many sections translated into English, including the patent title, abstract, and claims. Hence, only the English text of the collection has been indexed to create an index of English only documents. The CLEF-IP track provided two sets of topics; 300 training topics among which 89 are German, 15 are French, and the remainder are English; and 2000 test topics among which 520 are German, 134 are French, and the rest are English. For the cross language information retrieval experiments, the 89 German training topics and the 134 French test topics were selected to have a similar number of topics for each language and to allow the replication of the experiments.

Retrieval effectiveness is measured using two scores; mean average precision (MAP) and the recently introduced patent retrieval evaluation score (PRES). PRES is an evaluation score designed for recall-oriented challenging tasks when the objective is to find all possible relevant documents in the highest possible ranks. PRES emphasises the quality of the system in retrieving a large proportion of the relevant documents at relatively high ranks based on a user specific cut-off (Nₘₐₓ). Significance is tested using a 2-tailed t-test and a Wilcoxon test with p-value 0.05. Significance tests check whether the change in the results is classified as statistically significant or not, which means if a user using the system can feel that one system is significantly better than the other. In addition, the time for training the MT systems and the time for decoding (translating) the patent topics is calculated for both methods.

Since the patent collection comes from the EPO, most of the patents in the collection have the title and claims sections translated into three languages, namely, English, French, and German. Hence for the machine translation experiments, more than 8 million (˜8.1 million) parallel sentences in English, German, and French could be extracted from the collection. The average length of the English sentences in the corpus is 28 words.

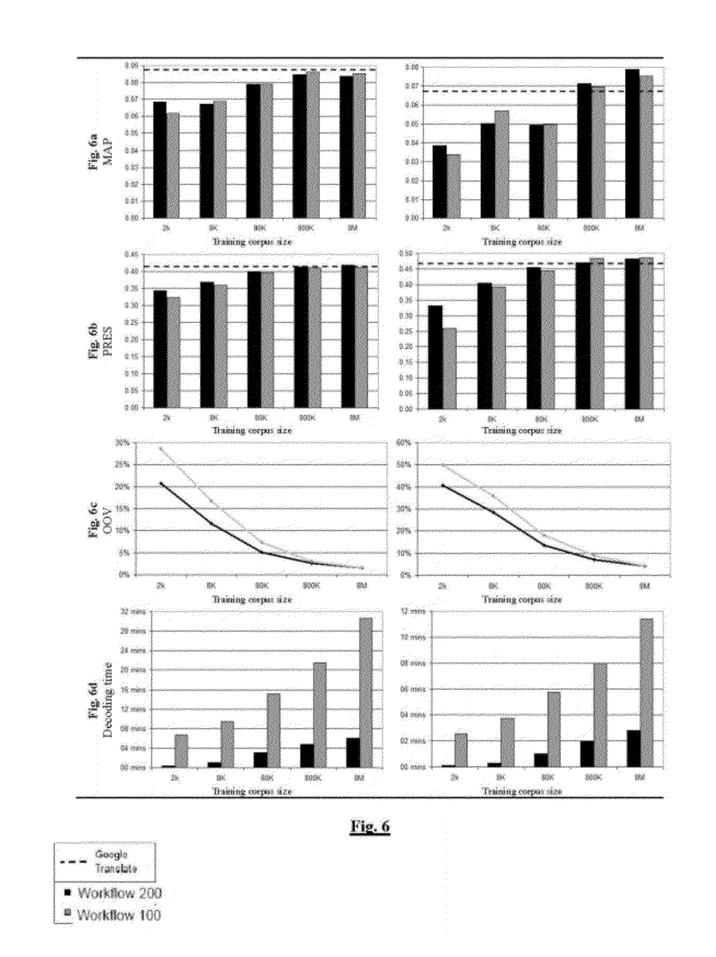

FIGS. 6a and 6b show the retrieval effectiveness when translating the French and German topics using an MT system implementing workflow 100 versus an MT system implementing the workflow 200 for different sizes of training data, compared using PRES and MAP. It can be seen that the difference in the retrieval effectiveness using both translation methods is not significant compared to each other for almost all training sizes. However, with small size training sets (2 k), it was found that the workflow 200 achieved significantly better retrieval effectiveness than the workflow 100 when compared using PRES for both languages. In addition, for the French topics when using workflow 200, results remained statistically indistinguishable from Google translate for training sizes 8M, 800 k, and 80 k. However, for the workflow 100, the 80 k training set translation led to a retrieval result that is statistically worse than Google translate when compared by PRES. These results highlight the higher effectiveness of the workflow 200 when only smaller sizes of training data are available.

To analyse the reason behind these results, the out of vocabulary (OOV) percentage while translating the patent topics is illustrated in FIG. 6c. It can be seen that the stemming performed in the “Text Processing” step 210 in the workflow 200 helps to overcome some of the OOV terms, which leads to the presence of a translation. Also, it can be noted that for small size training sets, the workflow 100 suffers from a large percentage of OOVs, while the workflow 200 overcomes part of this problem. The German topics suffer from higher OOV than the French ones because of the presence of compounds in German.

The second main benefit of the workflow 200 is illustrated in FIG. 6d, which compares the average decoding time required to translate a patent topic into English using both workflows. It is clearly shown that the workflow 200 is at least 5 times faster than the workflow 100 when using the same training parallel corpus. In addition, with smaller sizes training data sets, the speed of decoding using the workflow 200 can reach up to 23 times faster than the workflow 100.

Furthermore, the decoding time needed for the workflow 200 when it is trained with 8 million parallel sentences is comparable to the decoding time required for the workflow 100 when it is trained with only 2 k examples. Similar results to those shown in FIG. 6d were obtained for the training time for both workflows. The training time for the workflow 200 was 5 to 13 times faster than the training time for the workflow 100. For the memory usage, implementation of the workflow 100 had required 4.5 GB of RAM while decoding, while the implementation of the workflow 200 required only 1.7 GB of RAM while the decoding process on the same machine. This shows that the workflow 200 saves 62% of the memory usage.

It will be understood that what has been described herein is an exemplary cross language translation system. While the present teaching has been described with reference to exemplary arrangements it will be understood that it is not intended to limit the teaching to such arrangements as modifications can be made without departing from the spirit and scope of the present teaching.

It will be understood that while exemplary features of a system and methodology in accordance with the present teaching have been described that such an arrangement is not to be construed as limiting the invention to such features. A method of and a system for retrieving information may be implemented in software, firmware, hardware, or a combination thereof. In one mode, a method of and a system for retrieving information is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. The steps of the workflow 200 may be implemented by a server or computer in which the software modules 205, 210, 215, and 220 configured to implement the workflow 200 reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) 214, 270 may be programmed to perform the functions of the workflow 200. The processor(s) 214, 270 is a hardware device for executing software, particularly software stored in memory. Processor(s) 214, 270 can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. Processor(s) 214, 270 may also represent a distributed processing architecture such as, but not limited to, SQL, Smalltalk, APL, KLisp, Snobol, Developer 200, MUMPS/Magic.

Memory 280 is associated with processor(s) 270 and is operable to receive data from the TM module processor 214. Memory 280 and 217 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s) 214, 270.

The software in memory 217, 280 may include one or more separate programs. The separate programs comprise ordered listings of executable instructions for implementing logical functions in order to implement the workflow 200. In the example of heretofore described, the software in memory includes the one or more components of the method of and a system for retrieving information and is executable on a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). The operating system essentially controls the execution of other computer programs, such as the that provided by the present teaching, and provides scheduling, input-output control, file and data management, memory management, and communication control and related services.

The system provided in accordance with the present teaching may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

The I/O devices and components of the computer may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices may also include output devices, for example but not limited to, output modules for PLCs, a printer, bar code printers, displays, etc. Finally, the I/O devices may further include devices that communicate both inputs and outputs, for instance but not limited to, a modulator/demodulator (modem; for accessing another device, system, or network), a radio frequency (RF) or other transceiver, a telephonic interface, a bridge, and a router.

When the method of and system for retrieving information may be implemented in software, for example processing the methodology of the workflow 200, it should be noted that such software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

Any process descriptions or blocks in Figures, such as FIGS. 3, 4 and 5, should be understood as representing modules, segments, or portions of code which include one or more executable instructions for implementing specific logical functions or steps in the process, as would be understood by those having ordinary skill in the art.

It should be emphasized that the above-described embodiments of the present teaching, particularly, any “preferred” embodiments, are possible examples of implementations, merely set forth for a clear understanding of the principles. Many variations and modifications may be made to the above-described embodiment(s) without substantially departing from the spirit and principles of the present teaching. All such modifications are intended to be included herein within the scope of this disclosure and the present invention and protected by the following claims.

Although certain example methods, apparatus, systems and articles of manufacture have been described herein, the scope of coverage of this application is not limited thereto. On the contrary, this application covers all methods, systems, apparatus and articles of manufacture fairly falling within the scope of the appended claims.

The words comprises/comprising when used in this specification are to specify the presence of stated features, integers, steps or components but does not preclude the presence or addition of one or more other features, integers, steps, components or groups thereof.

1. A method of retrieving information from a data source, the method comprising:
receiving a query sentence in a source language by at least one processing module,
generating by a least one processing module a stemmed sentence by removing affixes from base words of the query sentence and by removing predetermined words from the query sentence,
generating by at least one processing module a translated sentence by translating the stemmed sentence into a target language, and
providing the translated sentence to an information retrieval module operable to retrieve information in the target language from the data source based on the translated sentence.

2. A method as claimed in claim 1, wherein the data source comprises a plurality of documents.

3. A method as claimed in claim 1, wherein the data source comprises metadata.

4. A method as claimed in claim 1, wherein the data source comprises relational databases.

5. A method as claimed in claim 1, wherein the data source comprises the World Wide Web.

6. A cross language information retrieval system comprising:
a user interface operable for receiving a query sentence from a user in a source language,
a processing module configured to generate a stemmed sentence by removing affixes from base words of the query sentence and by removing predetermined words from the query sentence, the processing module being further configured to generate a translated sentence by translating the stemmed sentence into a target language, and
an information retrieval module operable to retrieve information from a data source based on the translated sentence.

7. A system as claimed in claim 6, wherein the data source comprises a plurality of documents.

8. A system as claimed in claim 6, wherein the data source comprises metadata.

9. A system as claimed in claim 6, wherein the data source comprises relational databases.

10. A system as claimed in claim 6, wherein the data source comprises the World Wide Web.

11. A desktop search tool programmed to implement the method of claim 1.

12. A computer aided information retrieval environment comprising the system of claim 6.

13. An article of manufacture storing machine readable instructions which, when executed, cause a machine to:
provide a user interface for receiving a query sentence from a user in a source language,
generate a stemmed sentence by removing affixes from base words of the query sentence and by removing predetermined words from the query sentence,
generate a translated sentence by translating the stemmed sentence into a target language, and
provide the translated sentence to an information retrieval module operable to retrieve information in the target language from a data source based on the translated sentence.
